(19) United States
(12) Patent Application Publication
(10) Pub. No.: US 2025/0226124 A1
(43) Pub. Date: Jul. 10, 2025

(54) SYSTEMS AND METHODS FOR LIMITING CONTROL ELEMENT MOVEMENT IN NUCLEAR POWER PLANTS

(71) Applicant: GE-Hitachi Nuclear Energy Americas LLC, Wilmington, NC (US)

(72) Inventors: Oscar L. Meek, Wilmington, NC (US); David M. Curbo, Wilmington, NC (US); Allen R. Fisher, Wilmington, NC (US); Angelito N. Alvarez, Aurora, IL (US); Nathan T. Comer, Wilmington, NC (US)

(21) Appl. No.: 18/405,182

(22) Filed: Jan. 5, 2024

(51) Int. Cl. G21D 3/00

(52) U.S. Cl. CPC G21D 3/001

(57) ABSTRACT

Systems and methods provide reliable checks on nuclear core reactivity increases by proscribing certain types of removal of control elements. Controllers are associated with one or more limiters on control elements to stop withdrawal as needed, such as in erroneous or dangerous element movement scenarios. Controllers may use hardware not subject to software reprogramming to monitor, select, and control limiters and resultant element movement. Limiters may physically interrupt control elements and/or drives for the same, such as by being positioned in their normal operating ranges or eliminating their power. Limiters may use a reliable command from the controller to disengage and allow withdrawal; however, insertion or otherwise decreasing reactivity may be possible in any limiter state. Limiters and controllers may be installed in any plant and element configuration with proper positioning and sizing. Other reactor operations and element manipulations may not be affected, only unwanted or dangerous control element removals.

### BACKGROUND

FIG. 1 is a cross-sectional illustration of a related art control rod drive 10 useable in a nuclear reactor. For example, related art control rod drive 10 may be a Fine Motion Control Rod Drive (FMCRD) used in BWRs, although control elements in other types of reactors such as PRISM or sodium-cooled fast reactors may be similar. As shown in FIG. 1, control rod drive is housed outside, such as above or below, reactor pressure vessel 1, where drive 10 inserts or withdraws a control element, such as a control blade (not shown), attached thereto via bayonet coupling 15. Hollow piston 16 connects to bayonet coupling 15 and is vertically moveable inside of an outer tube in drive 10. Drive 10 includes ball screw 11 coupled with ball nut 12 that drives screw 11 vertically when rotated, such that hollow piston 16, bayonet coupling 15, and the control element attached thereto may be positioned with precision at desired positions in a nuclear reactor core. During scram, hollow piston 16 may be lifted off ball nut 12 by hydraulic pressure in the outer tube, permitting rapid movement and insertion of the control element. A magnetic coupling 17 pairs internal and external magnets to rotate ball screw 11 across a pressure barrier, and a motor and brake 19 mounted below drive and stop magnetic coupling 17 to desired positioning.

Power and control is provided to control rod drive by a Rod Control & Information System (RC&IS). This system may use all-digital or a mix of analog systems and digital transducers, including resolvers and synchros and encoders, and any required analogue-to-digital converters, coupled to motor and brake 19 to provide position detection, control, and power to the same. Mixed analog and digital systems are able to detect and resolve position of associated control elements to several centimeters, with coarser position control. All-digital systems are also possible for RC&IS, such as that described in U.S. Pat. No. 10,910,115 issued Feb. 2, 2021 to Nicholson et al. and incorporated by reference herein in its entirety. Related descriptions of drive 10 and FMCRD technology are found in GE-Hitachi Nuclear Energy, “The ESBWR Plant General Description,” Chapter 3-Nuclear Steam Supply Systems, Control Rod Drive System, Jun. 1, 2011, incorporated herein by reference in its entirety. Another related magnetic nuclear reactor control rod drive is found in U.S. Pat. No. 10,872,703 issued Dec. 22, 2020 to Morgan et al. and incorporated herein by reference in its entirety.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include systems that stop neutron-absorbing elements like control blades or rods from being pulled out, at all, partially, or fully, from the fuel in the core, such that the stopped element(s) continue reducing reactivity. Example systems include limiters, like physical blocks, interlocks, power cut-offs, etc., that control and limit, as needed, an associated control element from moving out of the core and a controller activating and/or de-activating selected limiters. The controllers may use a non-reprogrammable association between control element movement instructions and individual limiters to ensure that all, too many, or even more than one control elements cannot be withdrawn before an operator can understand and/or intervene in the action. Examples of interlocks include ratchets that touch directly to control rod drive components to physically block operations of the drives in a withdrawal direction but then selectively release and allow withdrawal upon receipt of a trusted command from the controller to disengage. Any block, shut-off, interlock, or other limiter may allow insertion of control elements at all times, thus not interfering with shutdown or adjustments to control elements to limit reactivity.

Example methods include installing limiter(s) for reactor control element(s) to stop the element(s) from any or all withdrawal motion and then further putting the limiter(s) in connection with a controller that can, at desired times and for desired periods, selectively disengage any individual or combination of limiters to permit withdrawal of the associated element(s). The reactor can otherwise be normally operated, including commercial electricity generation, including start-up and shut-down operations, and other industrial processes. Control element movements and repositioning intervals may occur normally and/or as desired from control room and/or plant operator instructions, with the exception of an instruction to move elements in a withdrawal position beyond a number or threshold allowed by the controller.

### BRIEF DESCRIPTIONS OF THE DRAWINGS

Example embodiments will become more apparent by describing, in detail, the attached drawings, wherein similar elements are represented by similar reference numerals. The drawings serve purposes of illustration only and thus do not limit example embodiments herein. Elements in these drawings may be to scale with one another and exactly depict shapes, positions, operations, and/or wording of example embodiments, or some or all elements may be out of scale or embellished to show alternative proportions and details.

FIG. 1 is an illustration of a related art nuclear control rod drive.

FIG. 2 is an illustration of an example embodiment system for limiting control element withdrawal in a nuclear reactor.

FIG. 3A and FIG. 3B are illustrations of an example embodiment withdrawal interlock.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

As used herein, “axial” and “vertical” directions are the same up or down directions oriented along the major axis of a nuclear reactor, often in a direction oriented with gravity. “Transverse” directions are perpendicular to the “axial” and are side-to-side directions at a particular axial height, whereas “radial” is a specific transverse direction extending perpendicular to and directly away from the major axis of the nuclear reactor.

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

The inventors have recognized that computerized and/or all-digital methods of operating control elements in nuclear reactors, while providing flexibility, more complex and finer operations, and remote reactor control, also increase the risk of malfunction and/or non-operation due to errors, such as incorrect automated programmed responses, malware, cyberthreats, etc. A particular new problem of operation for computerized operations recognized by the inventors is quick, potentially even simultaneous, over-withdrawal of control elements in a core without opportunity for operator intervention. This problem is not known in manual operation of individual control elements. This may result in unwanted excess reactivity and increased risk of plant damage. To overcome these newly-recognized problems as well as others, the inventors have developed example embodiments and methods described below to address these and other problems recognized by the inventors with unique solutions enabled by example embodiments.

The present invention is systems and methods of limiting control element withdrawal from nuclear reactors. In contrast to the present invention, the few example embodiments and example methods discussed below illustrate just a subset of the variety of different configurations that can be used as and/or in connection with the present invention.

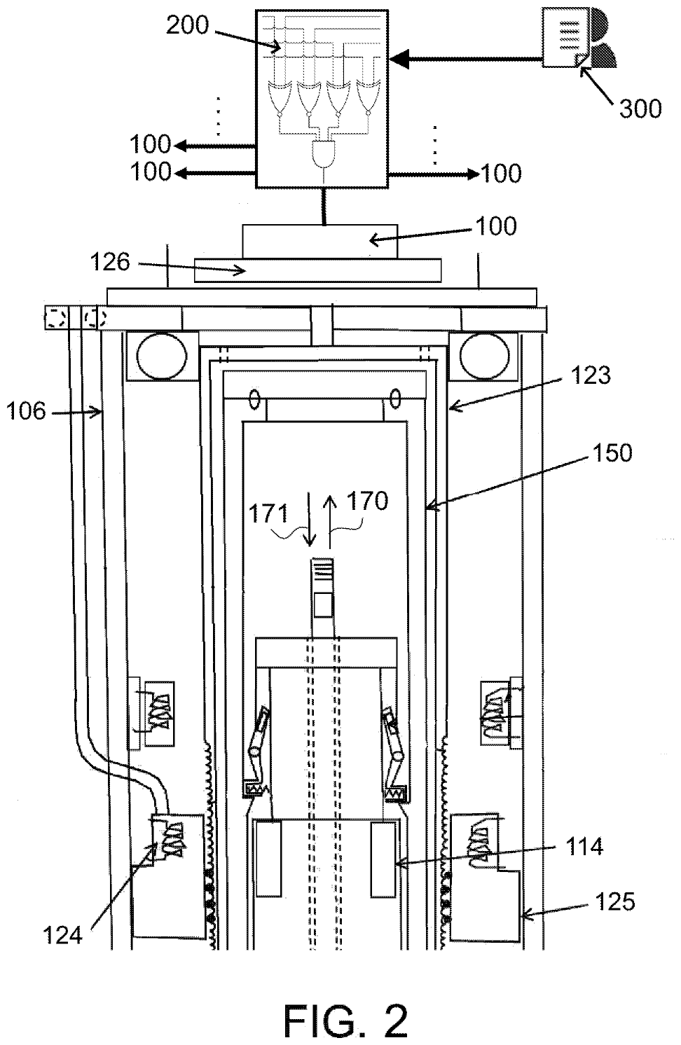

As seen in FIG. 2, an example embodiment withdrawal limitation system includes withdrawal controller 200 interfaced with one or more withdrawal interlocks 100 physically coupled with reactor control drive elements. For example, controller 200 may interface via a communicative connection with withdrawal interlocks 100 coupled with control elements across an entire nuclear reactor core or cores, or may interface with only interlocks 100 for a subset of drives or single drive. Examples of such subsets include drives with control elements used in control sequences or at highest reactivity points in the core. Controller 200 may further interface with an operator 300, which may be, for example, a computerized control rod drive system, plant control room, local human operator, algorithmic plant controller, etc. Controller 200 may be remote from, or local to, interlocks 100 and/or user(s) 300, with proper networking and communicative connections. These interfaces from operator 300 to interlocks 100 allow controller 200 to ultimately receive, send, process, and otherwise communicate signals and/or commands for operating control elements according to operator instructions in a safe manner.

Example embodiment controller 200 may be a hardware-based logic block, such as a circuit having analogue or physical logic arrangements that use non-software or -processor-based programming to generate outputs. Examples may include circuits with logic gates, analogue/digital shapers and converters, physical selection switches, etc. While controller 200 may be configured with software or conversion interfaces to, for example, receive digital signals and computerized instructions from operators 300, the optional use of hardware logic for output to interlocks 100 may prevent reprogramming or mitigate corruption of the output, such as from computer user error or malicious interference.

Controller 200 may be interfaced with any communicative connections to user 300 and interlocks 100, including optical or electrical wires and wireless signals, operating on digital or analogue signals including TCP/IP, analogue control signals, etc., with any needed software or analogue-to-digital conversion or vice versa for receipt and delivery of operational signals from user 300 to control elements and interlocks 100. Similarly, controller 200 may use exclusive and trusted connections to interlocks 100, such as insulated, hard-wired coaxial or power cables that ensure high-fidelity and controlled communications only between controller 200 and interlocks 100.

Example embodiment controller 200 is configured to disable less than all interlocks 100, which in turn prevents full withdrawal of all control elements in control drives having interlocks 100. For example, the logic circuit of controller 200 may be configured to output a release signal to only a single interlock 100 for a given core at any point in time or for a given set of command instructions. The logic circuit, for example, may associate a 5-bit digital code with 32 unique interlocks 100, and a particular interlock code must be received for the logic circuit to generate a release signal to the associated interlock 100. All other interlocks may remain in a physical configuration preventing rod withdrawal. Similarly, controller 200 may generate release signals for only a maximum number of interlocks at a time or per instruction, or always exclude and never issue release commands to particular interlocks, such as those beyond a certain withdrawal position or indicated for non-use during a particular operating cycle. In this way, controller 200 may operate in and enforce a less-than-all-control-elements-at-a time and/or less-than-all-control-elements-per-command withdrawal scheme.

As a specific example of the above code-based operation, an operator may erroneously instruct all control rod drives within a core to move their corresponding control elements to a more withdrawn position. The control rod drive system, as user 300, may then communicate with controller 200 as a part of executing this instruction. Any code or other communication from the control rod drives to controller 200, however, would result in a release command from controller 200 to less than all interlocks 100. The excluded interlocks by default mechanically prevent the control rod drives from executing the withdrawal, such that the full core withdrawal instruction cannot be executed. This may be true even if other portions of plant operations attempt to execute the withdrawal, such as control rod drive motors and/or released being actuated but unable to move due to interlocks 100. Any withdrawal instruction may need to be repeatedly entered for, or serially-advanced through, each control rod drive from controller 200 to achieve such withdrawal, at which point operators or other systems may recognize and/or intervene in the erroneous instruction, such as through instruction correction, a manual scram, deactivation of control rod drives, etc. Put another way, in this example, using a particular set of circuitry with set associations between instructions and unique, individual interlocks 100, example embodiment controller 200 physically cannot release or even communicate with all, or even more than one, interlock 100 to allow withdrawal of too many control elements.

Withdrawal interlock 100 structurally prevents withdrawal of control elements of connected drive(s), while allowing such withdrawal upon receipt of release signal from controller 200. Interlock 100 may not prevent or otherwise affect insertion. For example, upon receipt of a release signal from controller 200, interlock 100 may temporarily allow its associated control rod drive to operate in the withdrawal direction. Interlock 100 otherwise prevents withdrawal. As an initial operating state and after a threshold period of time, upon loss of the release signal, at failure, at loss of power, upon receipt of a lock signal, and/or at any other desired termination point, interlock 100 may physically prevent the control rod drive from driving the control element in the withdrawal position. In this way, interlock 100 may prevent withdrawal in all configurations except for a limited time upon receipt of a release signal.

In the example of FIG. 2 showing a magnetic Fine Motion Control Rod Drive (FMCRD), withdrawal interlock 100 may be limiting of or even directly connected to control rod drive motor 126 and allow, by default, motor 126 to rotate only in a vertically downward insertion direction. In this example, outer linear screw 123 moves scram coils 124 mounted on outer vertical travel nut 125. Scram coils 124 are energized to magnetically couple lift rod 112 via lift magnet 114 or other materials within an isolation barrier such as control rod drive pressure boundary 150. Control rod drive motor 126 rotates outer linear screw 123 within structural housing 106. Rotation of outer linear screw 123 causes vertical movement of outer vertical travel nut 125 and levitating and scram coils 124. Outer vertical travel nut 125 and energized levitating and scram coils 124 are moved vertically on outer linear screw 123 within the drive range, matching the stroke range of the associated control element. By allowing motor 126 to rotate only in a direction associated with insertion, in this case lowering, of these elements, interlock 100 may limit or prevent withdrawal of any associated element, even if motor is instructed and energized to rotate in a withdrawal direction.

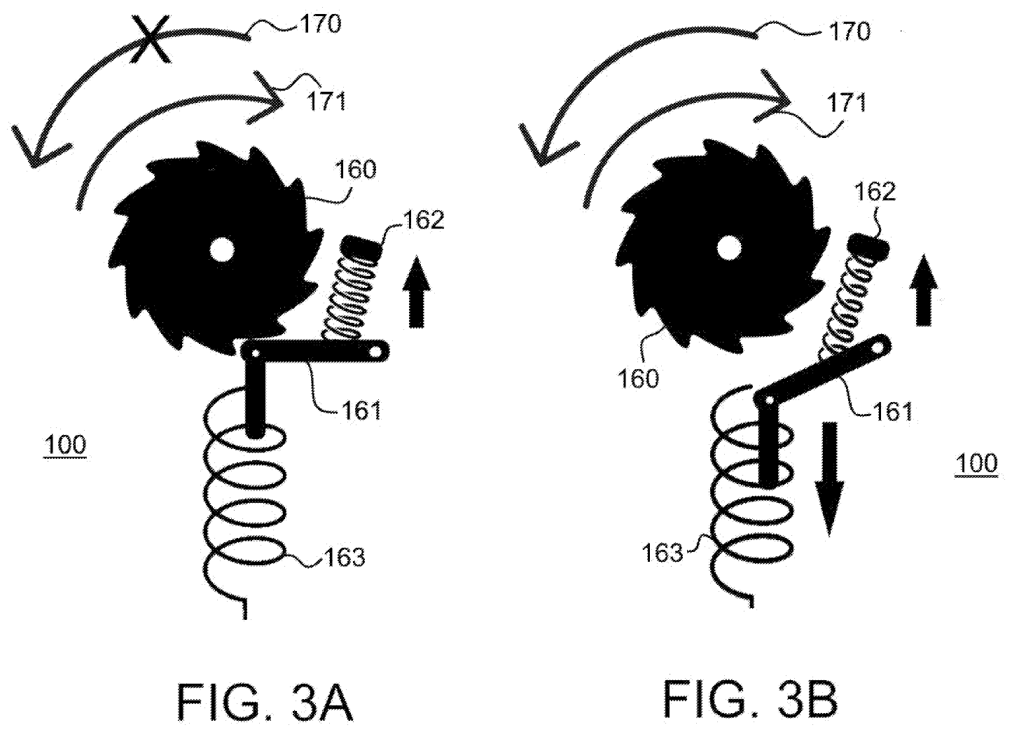

FIGS. 3A and 3B are illustrations of example embodiment interlock 100 that may prevent withdrawal through a ratchet. For example, rachet wheel 160 may be secured with motor 126 (FIG. 2) and strictly rotate with the same. In FIG. 3A, pawl 161 may seat into teeth of ratchet wheel 160 and be held in the teeth by spring 162 or other default force, preventing rotation of ratchet wheel 160 and motor and all connected elements in direction 170 associated with withdrawal. Movement in direction 171 associated with insertion may be permitted in any state.

In FIG. 3B, upon receipt of a release signal, solenoid 163 may actuate and pull a magnetic end of pawl 161 out of ratchet wheel 160. That is, solenoid 163 may be positioned and powered to overcome the force of spring 162 holding pawl 161 in the closed position. With pawl 161 removed, ratchet wheel 160 and motor and all elements powered thereby may turn freely in direction 170 associated with withdrawal and also direction 171 associated with insertion. When solenoid 163 deactivates, interlock 100 may return to its default position in FIG. 3A under force of spring 162, again stopping rotation in direction 170. Of course, although springs and solenoids with corresponding magnetic ends are used in this example embodiment, any other powered and/or non-powered biasing structures may be used, including permanent magnets, transducers, elastics, temperature-dependent depressors, manual force, etc. to create the default force keeping interlock 100 engaged and a corresponding selective overcoming force to disengage interlock 100 in response to the release signal. Such drives may be placed in appropriate positions to oppose one other in nearly any physical configuration and providing the selective engagement of interlocks 100.

The example of FIGS. 3A and 3B is one variation of selective rotation limitation using a ratchet. Other example embodiment interlocks 100 may similarly prevent and allow withdrawal of control elements at desired times. For example, interlock 100 may be a linear ratchet directly mounted on a shaft of a control element or control rod drive lifting rod that permits vertical insertion by default and allows withdrawal upon removal of a pawl from the linear teeth. Or, for example, interlocks 100 may be physical blocking elements insertable and removable via transducer from a vertical stroke range of the control element upon receipt of a limiting and/or release signal.

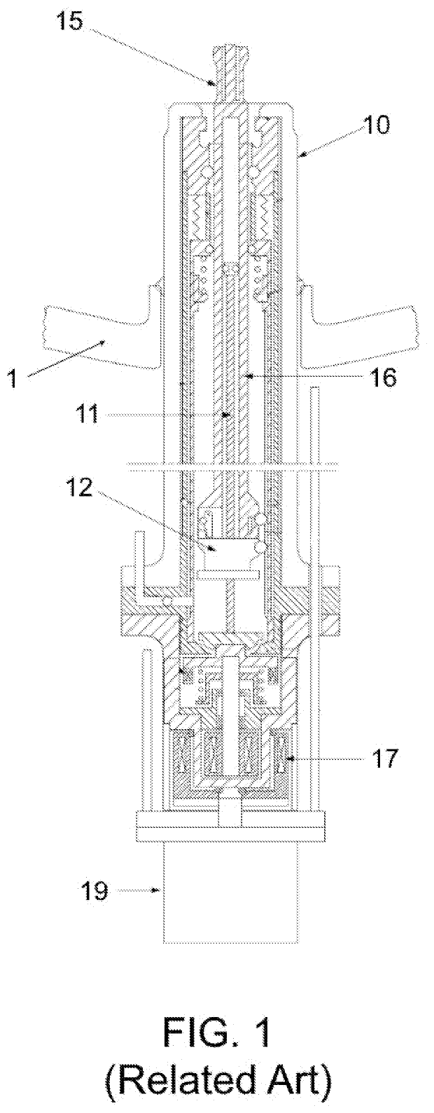

While the example control rod drive of FIG. 2 is shown with a downward vertical insertion direction, it is understood that upward insertion directions like those used in the control rod drive of FIG. 1 are also useable. Interlock 100 may simply be positioned with motor 19 at a bottom of the drive in the instance of FIG. 1. Interlock 100 may allow insertion, or upward movement, of the control element at any time, while permitting withdrawal, or downward movement, only upon receipt of the release command/withdrawal signal from a controller. Any other control element insertion and withdrawal motion is similarly controllable with interlocks 100 appropriately installed.

As discussed in connection with the trusted relationship between controller 200 and interlock 100, example embodiment interlocks may not be releasable absent the release command from controller 200. For example, interlock 100 may include no release and/or power source beyond the structures actuated only by the release signal from controller 200. Similarly, controller 200 may select only a subset, or only a single, interlock 100 to allow withdrawal of a control element, with no other interlocks in the core and/or interfaced with controller 200 being affected or released for withdrawal.

Interlock 100 and controller 200 may use any materials compatible with an operating nuclear reactor environment, including radiation-resilient materials that maintain their physical characteristics when exposed to high-temperature fluids and radiation without substantially changing in physical properties, such as becoming substantially radioactive, melting, brittling, retaining/adsorbing radioactive particulates, etc. For example, silicon carbide may be used for semiconductor materials with little radiation or elevated temperature interaction, and ceramics or metals such as stainless steels and iron alloys, nickel alloys, zirconium alloys, etc., including austenitic stainless steels 304 or 316, XM-19, Alloy 600, etc., are useable for various interlock components including those that may touch moveable control rod drive components. Similarly, direct connections between distinct parts and all other direct contact points may be lubricated, insulated, and/or fabricated of alternating or otherwise compatible materials to prevent seizing, fouling, metal-on-metal reactions, conductive heat loss, etc.

Some example embodiments and methods thus being described, it will be appreciated by one skilled in the art that examples may be varied through routine experimentation and without further inventive activity. For example, although some types of control rod drives found in commercial nuclear power plants are the target of some example embodiments and methods, it is understood that other control elements are useable with example embodiments and methods. Variations are not to be regarded as departure from the spirit and scope of the example embodiments, and all such modifications as would be obvious to one skilled in the art are intended to be included within the scope of the following claims.

1. A system for limiting withdrawal of control elements from a nuclear reactor core, the system comprising:
a limiter coupled with a control element for the core, wherein the limiter is configured to selectively block movement of the control element to a further withdrawn position within a stroke range of the control element; and
controller communicatively coupled with the limiter, wherein the controller is configured to transmit a withdrawal command to the limiter to cause the limiter to stop the blocking movement of the control element to the further withdrawn position.

2. The system of claim 1, further comprising:
a plurality of the limiters each coupled with a control element for the core, wherein the controller is communicatively coupled with all the limiters and configured to transmit the withdrawal command to less than all the limiters.

3. The system of claim 2, wherein the controller includes a circuit configured to select the less than all limiters to which to transmit the withdrawal command, and wherein the circuit selects without software.

4. The system of claim 3, wherein the circuit is further configured to select a single limiter to which to transmit the withdrawal command.

5. The system of claim 1, wherein the controller is communicatively coupled to the limiter only through a wired connection.

6. The system of claim 1, wherein the controller is further communicatively connected to a user operating the control elements of the nuclear reactor, and wherein the controller is configured to transmit the withdrawal command only in response to the user requesting withdrawal of at least one of the control elements.

7. The system of claim 6, wherein the user is at least one of a control rod drive system, an algorithmic plant controller, and a human plant operator.

8. The system of claim 1, wherein the limiter does not prevent movement of the control element to a less withdrawn position within the stroke range.

9. The system of claim 1, wherein the limiter is a ratchet and pawl secured with the control element, and wherein the ratchet and pawl when engaged block the movement of the control element to the further withdrawn position.

10. The system of claim 9, wherein the limiter further includes a non-powered drive pushing to engage the ratchet and pawl and a powered drive configured to push the ratchet and pawl to a disengaged position to stop the blocking the movement of the control element to the further withdrawn position upon receipt of the withdrawal command.

11. A nuclear power plant commercially generating electricity using heat generated from a nuclear reactor core controlled by insertion and withdrawal of control elements, the plant comprising:
at least one of the controllers of claim 1; and
a plurality of the limiters of claim 1 each coupled with a control element for the core.

12. A method of limiting control element withdrawal in a nuclear power plant, the method comprising:
coupling a limiter to a control element for the core, wherein the limiter is configured to selectively block movement of the control element to a further withdrawn position within a stroke range of the control element; and
communicatively connecting a controller to the limiter, wherein the controller is configured to transmit a withdrawal command to the limiter to cause the limiter to stop the blocking movement of the control element to the further withdrawn position.

13. The method of claim 12, wherein the limiter does not prevent movement of the control element to a less withdrawn position within the stroke range.

14. The method of claim 12, wherein the limiter is a ratchet and pawl secured with the control element, and wherein the ratchet and pawl when engaged block the movement of the control element to the further withdrawn position.

15. The method of claim 14, wherein the limiter further includes a non-powered drive pushing to engage the ratchet and pawl and a powered drive configured to push the ratchet and pawl to a disengaged position to stop the blocking the movement of the control element to the further withdrawn position upon receipt of the withdrawal command.

16. The method of claim 12, further comprising:
coupling a plurality of the limiters each to a control element for the core, wherein the communicatively coupling couples the controller to all the limiters, and wherein the controller is and configured to transmit the withdrawal command to less than all the limiters.

17. The method of claim 16, wherein the controller includes a circuit configured to select the less than all limiters to which to transmit the withdrawal command, and wherein the circuit selects without software.

18. The method of claim 16, further comprising:
receiving, from a user of the nuclear power plant, an instruction to withdraw at least one of the control elements; and
transmitting, from the controller, the withdrawal command to less than all the limiters.

19. The method of claim 19, further comprising:
moving only control elements coupled with the less than all limiters in a withdrawal directions; and
physically blocking, with other limiters, other control elements from moving in the withdrawal direction.

20. The method of claim 12, further comprising:
preventing the control element from all movement in a direction of the further withdrawal position within the stroke range, wherein the preventing is executed with the physical, secured position of the limiter.
